(19) United States
(12) Patent Application Publication
(10) Pub. No.: US 2008/0182587 A1
(43) Pub. Date: Jul. 31, 2008

(54) ATTRACTIONS NETWORK AND MOBILE DEVICES FOR USE IN SUCH NETWORK

(76) Inventor: Daniel Luke BENNETT, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/668,014

(22) Filed: Jan. 29, 2007

(51) Int. Cl. H04Q 7/20

(52) U.S. Cl. 455/456.2

(57) ABSTRACT

A mobile device network including a network server and a plurality of mobile devices. Each of the mobile devices includes an audio and/or video (A/V) capture section for obtaining an A/V file, a positioning section for ascertaining a geographic location of the mobile device, and a network transmitter for transmitting the A/V file and location information provided by the positioning section in association with the A/V file to the network server.

### TECHNICAL FIELD OF THE INVENTION

The present invention relates to mobile devices such as mobile phones, pagers, personal digital assistants, etc., and more particularly a network in which mobile devices may share information regarding various attractions (e.g., points of interest, etc.).

### DESCRIPTION OF THE RELATED ART

People today oftentimes find themselves in places where they are looking for things to do or see. For example, tourists and business travelers frequently find themselves in unfamiliar cities or elsewhere where they are interested in seeing local attractions or areas of personal interest, finding unique restaurants, etc. Currently, people are limited to information obtained via word of mouth, the Internet, commercial tourist guides or brochures, and the like.

Commercial tourist guides and brochures are frequently somewhat dated insofar as the information contained therein, for example with respect to trendy restaurants or nightclubs. Moreover, the information contained in the guides or brochures is oftentimes dependent upon whether a commercial fee has been paid for inclusion in the guide. Furthermore, people may not always have ready access to such guides or brochures.

Global positioning system (GPS) based navigation systems have become increasingly common and are now typically found in automobiles as well as various types of portable devices. Such navigation systems are designed primarily for the purpose of providing directions or mapping from one location to another. The navigation systems may provide additional information relating to various points of interest (e.g., restaurants) or other types of attractions (e.g., sports stadiums). However, such additional information is typically limited simply to the particular locations of such attractions. Furthermore, the particular points of interest or attractions included in the navigation system are dependent upon the commercial entity providing the navigation system. Consequently, which attractions are included in the navigation system database and which attractions are not included may be based simply on whether or not a commercial fee has been paid to the navigation system provider.

Additionally, GPS navigation systems do not provide users themselves with the ability to provide information regarding a particular point of interest or attraction. For example, a tourist or business traveler may happen upon a place such as a local pub, restaurant or historical sight. The tourist or business traveler may desire to make a notation of such attraction and share such information with other tourists, business travelers, etc. GPS navigation systems provide little if any utility in this regard.

In view of the aforementioned shortcomings, there exists a strong need in the art for a means by which people may promptly obtain detailed information relating to various attractions. Moreover, there is a strong need in the art for a means by which people may provide their own information, comments, suggestions, etc. with regard to various attractions.

### SUMMARY

According to an aspect of the invention, a mobile device network is provided. The network includes a network server and a plurality of mobile devices. Each of the mobile devices includes an audio and/or video (A/V) capture section for obtaining an A/V file, a positioning section for ascertaining a geographic location of the mobile device, and a network transmitter for transmitting the A/V file and location information provided by the positioning section in association with the A/V file to the network server.

According to another aspect, each mobile device further includes a user interface that enables a user to input information relating to the A/V file.

In accordance with still another aspect, the network server comprises a database for storing A/V files provided by the plurality of mobile devices along with the location information associated with the A/V files.

According to another aspect, the network server further comprises a search engine for accessing the A/V files in the database as a function of the location information associated with the A/V files.

According to yet another aspect, each mobile device comprises a request engine that enables a user to generate an information request that includes location information provided by the positioning section, and the network transmitter transmits the information request to the network server.

In yet another aspect, in response to receiving the information request from the mobile device, the network server search engine identifies particular ones of the A/V files and/or information associated with the A/V files from the database based on the location information included in the information request.

In accordance with another aspect, the information request further includes particular search criteria provided by the user via the mobile device, and the search engine identifies the particular ones of the A/V files and/or information associated therewith based on the particular search criteria.

According to still another aspect, the network server transmits all or part of the identified A/V files and/or information associated therewith to the mobile device that had provided the information request.

With still another aspect, the request engine in the mobile is enabled to allow a user to generate a request for more detailed information regarding the all or part of the identified A/V files and/or information associated therewith in response to receiving the all or part of the identified A/V files and/or information associated therewith.

According to another aspect, the A/V capture section comprises a camera for capturing a scene representative of a current geographic location of the mobile device to produce an image-based file, and the positioning section ascertains the current geographic location of the mobile device.

In accordance with another aspect, the network transmitter automatically attaches the current geographic location of the mobile device to the image-based file prior to being uploaded to the network server.

In still another aspect, the mobile device enables a user to attach additional information to the image-based file prior to being uploaded to the network server.

According to another aspect, the additional information includes at least one of user description, comments, ratings or user group affiliation.

Yet another aspect of the invention relates to a mobile device including an audio and/or video (A/V) capture section for obtaining an A/V file, a positioning section for ascertaining a geographic location of the mobile device, and a network transmitter for transmitting the A/V file and location information provided by the positioning section in association with the A/V file to a network server.

According to another aspect, the mobile device further includes a user interface that enables a user to input information relating to the A/V file.

In accordance with another aspect, the mobile device comprises a request engine that enables a user to generate an information request that includes location information provided by the positioning section, and the network transmitter transmits the information request to the network server.

According to still another aspect, the information request further includes particular search criteria provided by the user via the mobile device, and the search engine identifies the particular ones of the A/V files and/or information associated therewith based on the particular search criteria.

In still another aspect, the A/V capture section comprises a camera for capturing a scene representative of a current geographic location of the mobile device to produce an image-based file, and the positioning section ascertains the current geographic location of the mobile device.

In yet another aspect, the network transmitter automatically attaches the current geographic location of the mobile device to the image-based file prior to being uploaded to the network server.

With still another aspect, the mobile device enables a user to attach additional information to the image-based file prior to being uploaded to the network server.

According to still another aspect, the additional information includes at least one of user description, comments, ratings or user group affiliation.

In still another aspect, the mobile device comprises a positioning section for ascertaining a geographic location of the mobile device, a network transmitter which transmits a request for information onto a network, the request including location information provided by the positioning section and a network receiver for receiving one or more A/V files relating to the location information in response to the request.

With still another aspect, the mobile device further includes a user interface that enables a user to input search criteria that is included in the request.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is an environmental view of an attractions network for mobile devices in accordance with an exemplary embodiment of the present invention;

FIG. 2 is a front perspective view of a mobile device in accordance with an exemplary embodiment of the present invention;

FIG. 3 is a rear perspective view of the mobile device of FIG. 2;

FIG. 4 is an exemplary display on the mobile device illustrating various historical points of interest located proximate the geographic location of the mobile device in accordance with the present invention;

FIG. 5 is an exemplary display on the mobile device illustrating additional detail on the points of interest shown in the display of FIG. 4 in accordance with the present invention;

FIG. 6 is an exemplary display on the mobile device illustrating additional detail on a particular point of interest;

FIG. 7 is an exemplary display on the mobile device illustrating various nightlife attractions located proximate the geographic location of the mobile device in accordance with the present invention;

FIGS. 8A-8F illustrates exemplary displays on the mobile device for enabling a user to upload A/V files (e.g., pictures, videos) to a network server in accordance with the present invention;

FIG. 9 is an exemplary display on the mobile device for enabling a user to provide an information request to the network server in order to obtain information in accordance with the present invention;

FIG. 10 represents an exemplary method suitable for enabling a mobile device to allow a user to request information regarding attractions in accordance with the present invention;

FIG. 11 represents an exemplary method suitable for enabling a network server to process a request for information in accordance with the present invention;

FIG. 12 represents an exemplary method for enabling a mobile device to allow a user to upload audio and/or video (A/V) files to a network server in accordance with the present invention;

FIG. 13 represents an exemplary method enabling a network server to store A/V files and corresponding information provided by mobile devices in a database in accordance with the present invention.

FIG. 14 illustrates an exemplary database structure in accordance with the present invention;

FIG. 15 is a functional block diagram of a network server in accordance with an exemplary embodiment of the present invention; and

FIG. 16 is a functional block diagram of a mobile device in accordance with an exemplary embodiment of the present invention.

### DETAILED DESCRIPTION OF EMBODIMENTS

The present invention will now be described in relation to the drawings, wherein like reference labels are used to refer to like elements throughout.

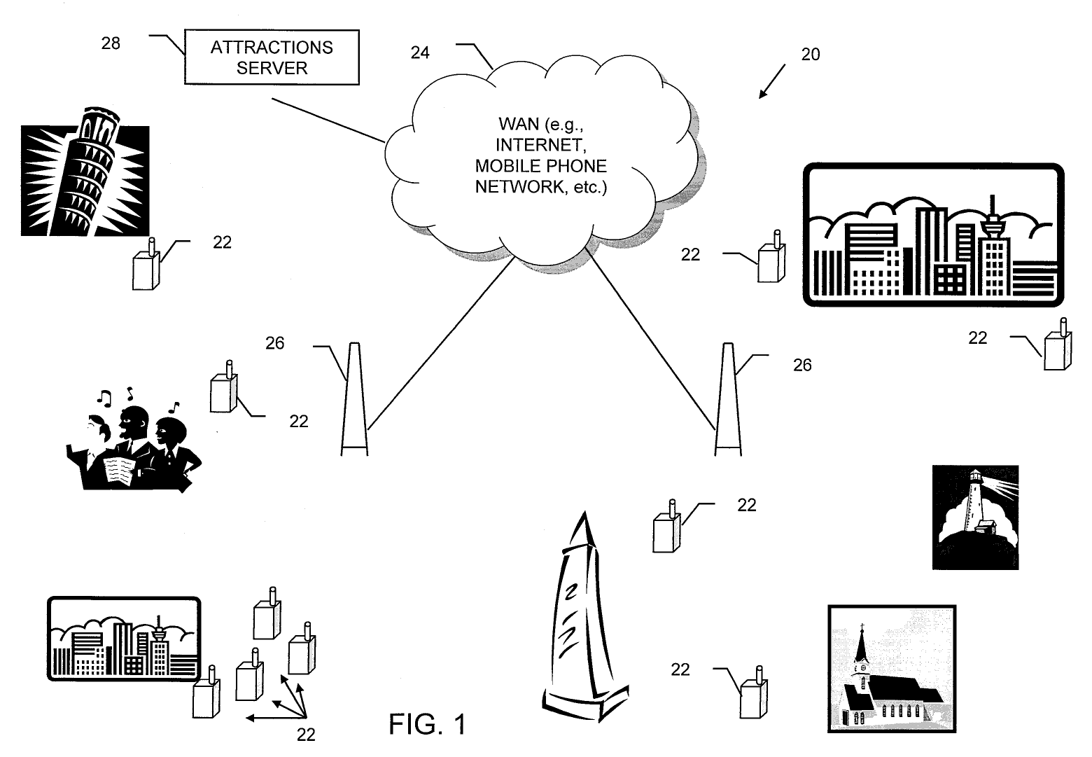

Referring initially to FIG. 1, an attractions network 20 is shown in accordance with an exemplary embodiment of the present invention. The network 20 is built primarily around a plurality of mobile devices 22. In the exemplary embodiment, the mobile devices 22 are mobile phones 22, although other types of mobile devices or combinations thereof may be used without departing from the scope of the invention.

The mobile devices 22 are interconnected via a wide area network (WAN) infrastructure 24. The WAN 24 may be any existing infrastructure (e.g., Internet, mobile phone network, satellite network, etc.), a proprietary network, or any combination thereof. In the exemplary embodiment, the mobile devices 22 are coupled to the WAN 24 via regional communications towers 26 and mobile phone system providers such as Cingular, Verizon, Alltel, etc. Nevertheless, the particulars of the WAN infrastructure are not germane to the present invention, and hence further detail has been omitted herein for sake of brevity.

According to the present invention, the users of the mobile devices 22 may be tourists, business travelers or anyone else desirous of information relating to attractions in their surrounding area. Alternatively, the users of the mobile devices 22 may be desirous of providing information relating to attractions in their surrounding area. At any given time, the mobile devices 22 may be located anywhere within the coverage of the WAN 24. Such coverage may encompass any geographic region, e.g., local, nation, worldwide, etc. The attractions network 20 enables users of the mobile devices 22 to access one or more attractions servers 28 also coupled to the WAN 24.

As will be described in more detail below, the mobile devices 22 preferably each include a positioning system (e.g., a global positioning system (GPS) receiver) that is able to ascertain the geographic location of the mobile device 22. Based on the location of the mobile device 22, the user is able to download information from the attractions server 28 relating to attractions in the area surrounding the location of the mobile device 22. The attractions may include nearby restaurants, bars, nightclubs, public parks, historical landmarks, etc. Information may include comments from other users regarding the quality of food at a particular restaurant, particular attractions that one does not want to miss, etc. In addition, such information may include user ratings information (e.g., zero to five stars) ranking the attractiveness of the particular attractions, etc. Still further, the information may include audio and/or visual (A/V) information such as pictures, videos, sound clips, etc. provided by users in relation to the attractions. Moreover, the information may include map information and/or directions from the user's current location to a particular attraction. Such information provides the users requesting information with a visual and/or audible impression of the attractions in addition to conventional text such that the user requesting the information can better assess his or her interest in the attraction.

Conversely, the present invention also allows the users of the mobile devices 22 to create information relating to particular attractions and upload such information to the attractions server 28 so that other users may subsequently benefit from the information as describe above. As is described in more detail below, the user of a mobile device 22 may obtain pictures and/or videos of particular attractions via a camera included within the mobile device 22. In addition, or in the alternative, the user may capture sound clips relating to particular attractions via a microphone and audio recorder built into the mobile device 22. The mobile device 22 stores such pictures, videos, audio clips, etc. as digital files, referred to herein as A/V files. Further, the mobile device 22 may include a keypad or other input means that allows the user to input comments, ratings information, etc. The mobile device 22 transmits such A/V files and other user information to the attractions server 28 via the WAN 24. In addition to such information, the mobile device 22 utilizes the positioning system (e.g., GPS receiver) included within the mobile device 22 to provide location information associated with the A/V files and information input by the user. Preferably, the mobile device 22 provides the location information automatically in conjunction the A/V files and information provided by the user via the mobile device. For example, whenever the user takes a picture or video using the mobile device 22, the mobile device 22 automatically attaches an information tag to the A/V file containing the picture or video. The information tag includes the geographical location coordinates of the mobile device 22 at the time such picture or video was taken.

Thus, a user visiting a historical site, for example, may take a picture of a monument using the mobile device 22. As will be explained in more detail below, the mobile device 22 prompts the user to enter any comments, ratings information, etc. into the mobile device 22 to be associated with the picture of the monument. In addition, the mobile device 22 automatically attaches an information tag to the picture indicating the geographic location of the mobile device 22, and hence the proximate location of the monument together with any information input by the user. The user may choose to upload the picture of the monument together with the other information to the attractions server 28. As a result, subsequent users may download the information regarding the monument from the attractions server 28. For example, a tourist, business traveler, etc. using a mobile device 22 may be in the general area of the monument. The user may request information regarding surrounding attractions from the attractions server 28. The request includes the geographic location of the mobile device 22 at the time of the request. The attractions server 28 accesses information contained in its database to find attractions that are located proximate the mobile device 22 requesting the information. For example, the attractions server 28 may access information relating to attractions that are within a selected radius of the mobile device 22. In addition, the request may include preferences on the part of the user requesting the information. For example, the request may specify categories such as historical points of interest, nightlife attractions, etc. The attractions server 28 accesses information in its database meeting such criteria and provides it to the user via the mobile device 22.

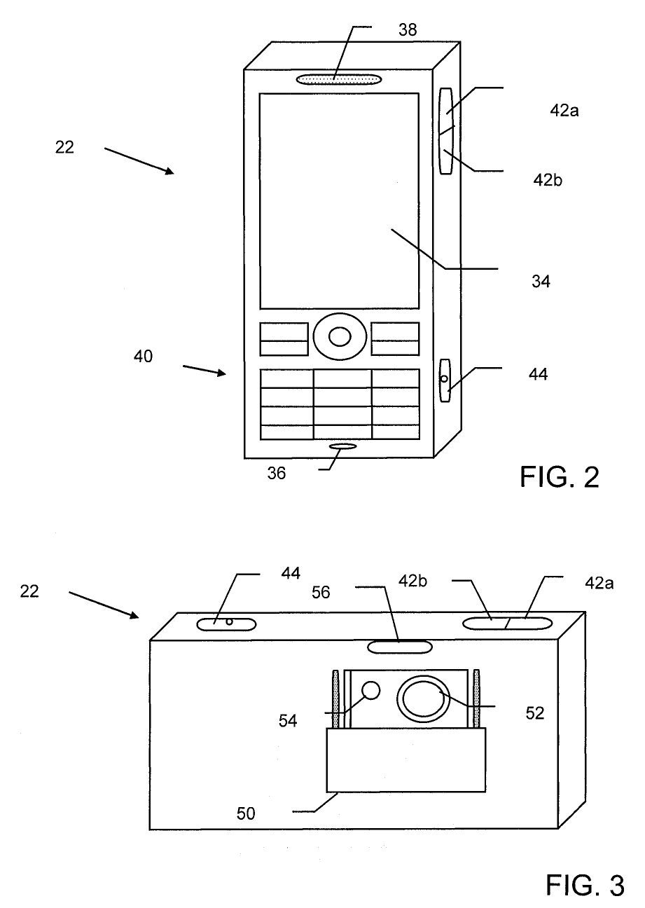

Consequently, users of mobile phones 22 or other type mobile devices 22 have quick and convenient access to information, including A/V files, relating to attractions in the same geographic location. Moreover, users of mobile phones 22 or other type mobile devices 22 have the ability to provide their own information relating to particular attractions, including providing A/V files. Furthermore, it will be appreciated that a given mobile device 22 need not be able to both access information from the server 28 and upload information to the server 28. For example, a given mobile device 22 may be configured simply to request information, whereas another mobile device 22 may be configured only to upload information. For optimum utility, however, a given mobile device 22 is capable of both providing and receiving information relating to attractions. Turning to FIGS. 2 and 3, an exemplary mobile device 22 is shown. The mobile device 22 is shown as a mobile phone; however, it will be appreciated that the mobile device may be any other type of mobile device such as a PDA, pager, media player, camera, etc.

As is shown in FIG. 2, the mobile phone 22 includes a liquid crystal display 34 serving as a graphical user interface (GUI). The display 34 provides a display of various types of information as is conventional. For example, the display 34 may display the operational status of the phone 22, contact information, menu information, text, graphics, images, videos, etc. When the mobile phone 22 is utilized as a camera, the display 34 may function as an electronic viewfinder to aid the user when taking a photograph or video. In addition, in the case where the display 34 is a touch sensitive display, the display 34 may serve as an input device to allow the user to input data, menu selections, attraction information, etc.

The mobile phone 22 further includes a microphone 36 and a speaker 38. As is conventional, the microphone 36 and speaker 38 allow a user to carry out conventional voice communications by placing the phone 22 adjacent the user's ear. In addition, the mobile phone 22 includes a keypad 40 having an assortment of keys. The keypad 40 facilitates user input and operation of the mobile phone 20 as is conventional. For example, the keypad 40 may include keys for navigating the menus displayed on the display 34, selecting predefined functions such as camera operation, initiating or terminating a call, etc.

The mobile phone 22 also may include other keys or buttons useful in the operation of the mobile phone 22. For example, the mobile phone 20 includes buttons 42a and 42b mounted on a side face of the mobile phone housing. During use of the mobile phone 20 as a telephone or media player, the buttons 42a and 42b serve as a convenient means to allow a user to adjust the volume up or down, respectively. In addition, the mobile phone 22 includes a button 44 that allows a user to answer or “pick up” an incoming call simply by pressing the button 44.

Furthermore, when the mobile phone 22 operates as a camera (e.g., still and/or video) buttons 42a and 42b respectively function to increase and decrease the amount of zoom provided by the camera. The button 44, on the other hand, functions as a shutter or on/off button for capturing pictures or videos.

FIG. 3 illustrates a typical orientation of the mobile phone 20 when utilized as a camera. As is shown, the rear of the housing includes a slidable cover 50. When open as shown in FIG. 3, the cover 50 exposes a camera lens 52 and an autofocus transducer 54. When the cover 50 is closed, the camera lens 52 and autofocus transducer 54 are protected from dirt, dust, scratches, etc. The mobile phone 22 also includes a flash element 56 for providing light under low lighting conditions.

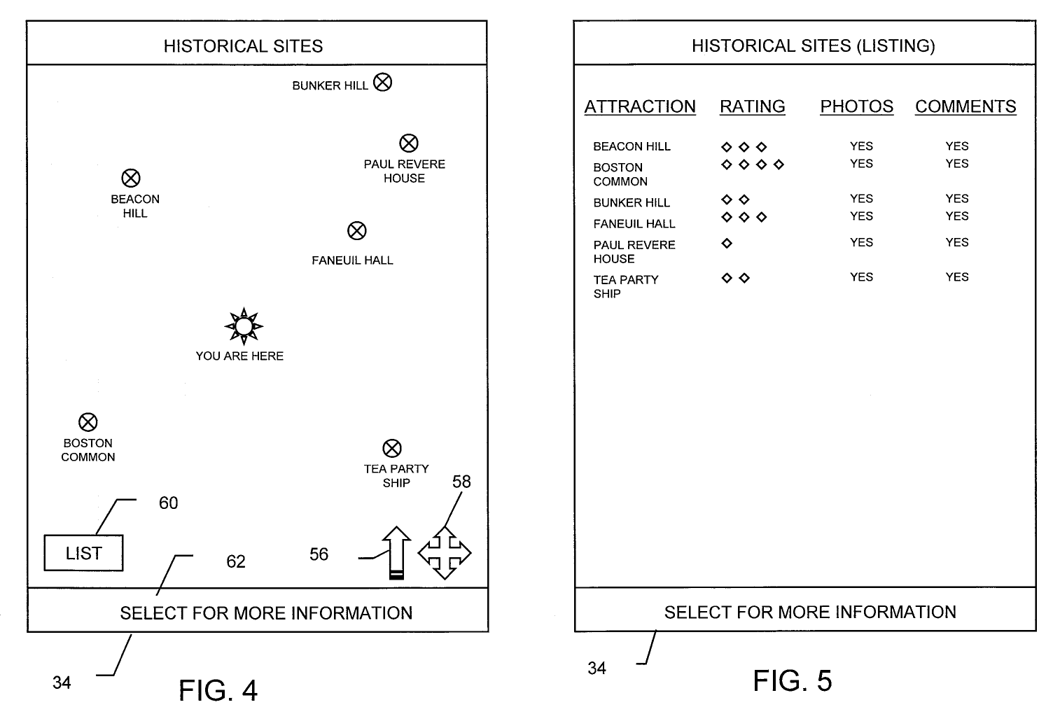

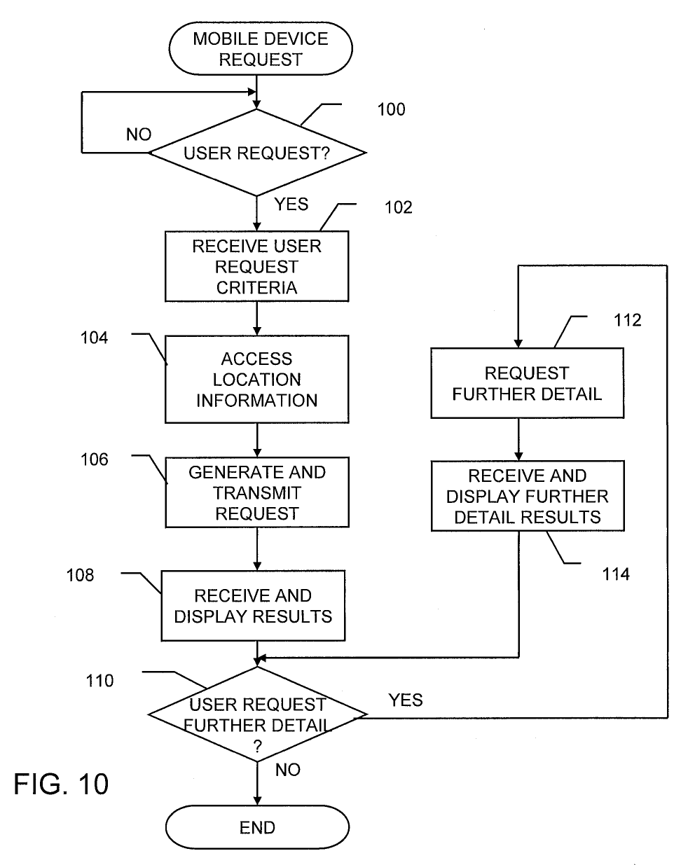

FIGS. 4-7 illustrate exemplary displays on a mobile device 22 when a user requests information relating to attractions in accordance with the present invention. In FIG. 4, the user has requested that the attractions server 28 provide information on attractions in the area proximate the location of the user. For example, the user is a tourist in Boston and would like information on historical sites in the area. Using a procedure described in more detail below with respect to FIG. 10, the user enters a request into his or her mobile device 22. The user enters such features as the particular areas of interest (e.g., historical sites), the desired radius (e.g., 1-5 miles), minimum ratings level, etc. The mobile device 22, based on the location determined by its positioning system at the time of the request, automatically enters location information in the request. The mobile device 22 then transmits the request to the attractions server 28 via the WAN 24. The attractions server 28 in turn searches its database for any attractions meeting the criteria specified in the user's request. The attractions server 28 then transmits the information from its database to the mobile device 22. The mobile device 22 in turn displays the information as exemplified in FIG. 4.

Thus, the display 34 in FIG. 4 illustrates a number of historical attractions located proximate the location of the user. The display 34 may provide map information on the display such as the surrounding streets, buildings, etc. similar to existing navigation systems. Highlighted on the display are the area attractions identified by the attractions server 28 (e.g., Beacon Hill, Faneuil Hall, Boston Common, etc.). The user may zoom in or out on the display 34 via a zoom control bar 56, for example, to zoom in on directions to a particular location, or to zoom out to obtain more of a bird's eye view. Similarly, the user may shift the geographic area covered by the display via a shift control 58. The zoom control bar 56 and shift control 58, as with the other controls/inputs described herein, may be operated via a touch display 34 or via the keypad 40, for example.

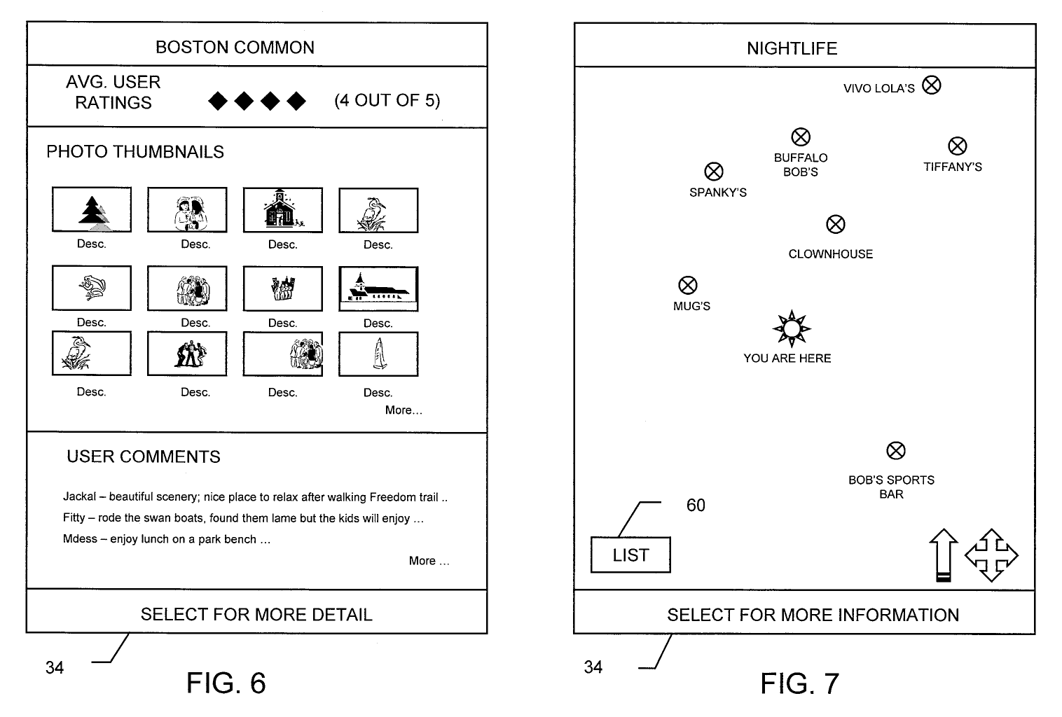

Furthermore, the user may “drill down” via various menus and/or displays to obtain more information from the attractions server 28 with respect to the various attractions shown on the display 34. For example, a user may press a “List” button 60 on the display 34 in FIG. 4 in order to present a listing of the particular attractions as exemplified in FIG. 5. The listing may include additional information provided by the attractions server 28 such as user rating information and whether photographs/videos and/or comments are available regarding the particular attraction. Thus, by pressing “Boston Common”, for example, the display 34 presents ratings, photograph thumbnails, and/or comments via the display 34 as represented in FIG. 6, for example. In another embodiment, the mobile device 22 of the user requesting information may obtain information from the attractions server 28 regarding other types of points of interest (e.g., nightlife as exemplified in FIG. 7).

The particular manner in which the information is displayed to the user on the display 34 is intended merely to be exemplary. As will be appreciated, the mobile device 22 may be configured to allow the user to navigate through the information in a variety of different ways. For example, in FIG. 4 the user may request additional information by highlighting one or more of the displayed attractions and then pressing a display bar 62 to request additional information on the highlighted attractions. Similarly, in FIG. 5 a user may navigate directly to photographs of a particular attraction by simply highlighting “Yes” under “Photos” for the desired attraction(s). Thus, the present invention is not intended to be limited to any particular menu navigation approach in its broadest sense.

According to the present invention, there is an exchange of information between the mobile devices 22 and the attractions server 28. It is expected that such information will be communicated digitally over the network 20, although the present invention is not intended to be limited to any particular type of communication. A variety of forms or formats could be used for the communications between the mobile devices 22 and the server 28. Any known format is acceptable without departing from the scope of the invention.

Furthermore, to the extent that the present invention enables a user to “drill down” for more detail relating to particular attractions, the exchange of such information between the attractions server 28 and the requesting mobile device 22 can be handled in any known manner. For example, the bandwidth of the connection between the attractions server 28 and the mobile device 22, and the available memory in the mobile device 22, will affect the amount of data that can be communicated and stored in a given amount of time. Therefore, the system may be designed such that the attractions server 28 transmits all the requested attraction information at one time (including all the photographs, comments, etc. for all of the attractions), or transmits only a given amount of information or level of detail at a given time. If the user requests additional information by “drilling down”, this may form a separate request sent to the attractions server 28 which responds in turn by transmitting the additional detail to the mobile device 22. For purposes of simplicity of explanation, all of such situations are described herein simply as a request by the user of the mobile device 22.

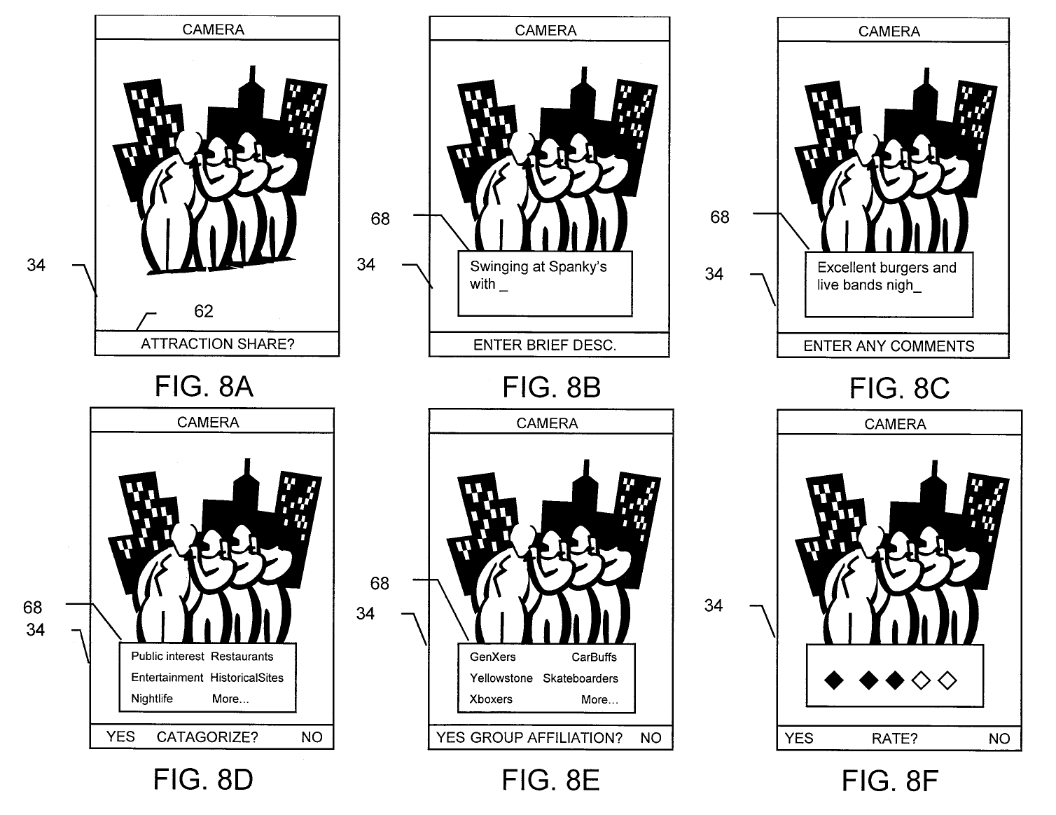

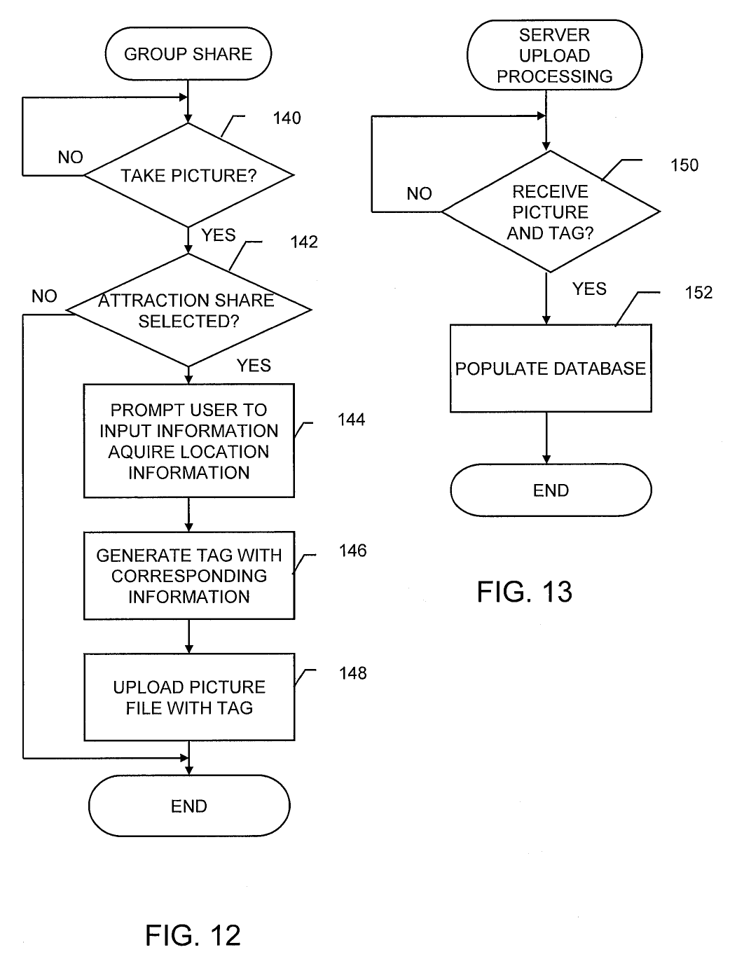

Referring now to FIGS. 8A-8F, an exemplary procedure is illustrated for allowing the user of a mobile device to create and upload information relating to a particular attraction. Additional detail is discussed below in connection with FIG. 12.

FIG. 8A illustrates the display 34 of a mobile device 22 after a user has taken a picture via the camera included in the mobile device 22. For example, the user in FIG. 8A has taken a picture of a group of people singing at a restaurant. In accordance with the invention, the mobile device 22 automatically prompts the user via the display bar 62 as to whether the user wishes to share the attraction with others. The user responds by entering a response via the touchpad display 34, keypad 40, or the like. If the user responds “Yes”, the mobile device 22 prompts the user to enter a brief description of the attraction as represented in FIG. 8B. The user may then enter a text description that is displayed in a text box 68, for example. Upon entering the description, the mobile device 22 prompts the user to enter any comments the user may have regarding the attraction. Next, as represented in FIG. 8D, the mobile device 22 prompts the user to enter whether the attraction is to be categorized with one more predefined categories such as “public interest”, “restaurants”, “entertainment”, “historical sites”, etc. The mobile device 22 may display the categories from which the user may choose in the text box 68 as shown.

The user is then prompted by the mobile device 22 to enter whether the attraction is to be associated with any group affiliation established within the network 20. As is common, user groups are often established involving users sharing a common interest, demographic, etc. Thus, as shown in FIG. 8E, the mobile device 22 may prompt the user to enter such group share information via prompts provided in the text box 68, for example. Next, the mobile device 22 prompts the user to enter any ratings information, e.g., how the user would rate the attraction on a basis of zero to five stars. It will be appreciated that the user may choose to skip any or all of the particular steps shown in FIGS. 8A thru 8F.

The mobile device 22 stores the information entered by the user as represented in FIGS. 8A-8F. Upon all the information being input, the mobile device 22 attaches such information to the picture. In addition, the mobile device 22 attaches the aforementioned information indicating the geographic location of the mobile device 22 at the time of taking the picture so as to associate a geographic location with the attraction shown in the picture. In the context of the invention, information is considered “attached” to the picture or other A/V file as long as there is some way for the attractions server 28 to associate the information with the A/V file. This may be by including the information in the same data packet as the A/V file when transmitted by the mobile device 22 to the attractions server 28. Alternatively, for example, this may be by providing information such as an identification tag which associates any and all information corresponding to the A/V file regardless of whether the information and A/V file are transmitted to the attractions server 28 as part of the same transmission or different transmissions as will be appreciated.

Although FIGS. 8A-8F exemplify the invention in association with a picture, it will be appreciated that the same procedure can be utilized in association with any other type of A/V file representing an attraction (e.g., video, audio clip, etc.).

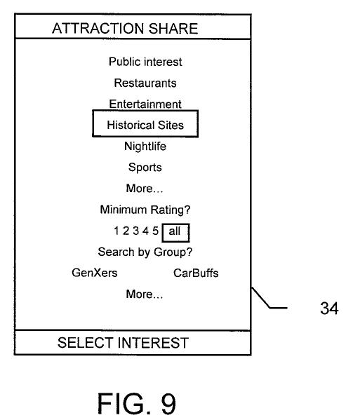

FIG. 9 illustrates an exemplary display 34 on a mobile device 22 in a case where the user wishes to request information from the attractions server 28 regarding particular attractions in the area proximate the user. For example, the display 34 shows a selection of categories, minimum ratings, share groups, etc. The user may enter such information by selecting the particular category or categories, minimum ratings, desired location radius, etc. via a touch pad display 34, the keypad 40, etc. The mobile device 22 in turn stores such request information or criteria so that it may be transmitted to the attractions server 28 as described in more detail below. The attractions server 28 may then download to the mobile device 22 the particular attractions meeting the selected criteria.

FIG. 10 is a flowchart suitable for programming a mobile device 22 to operate in accordance with the procedure exemplified in FIGS. 4-7 for obtaining information regarding surrounding attractions. In step 100, the mobile device 22 determines if the user has requested attractions information (e.g., as a result of a user entering a predefined input via a display menu request or the like indicating a desire to obtain information). In step 102, the mobile device 22 receives the user request criteria as exemplified in FIG. 9, for example, by prompting the user to enter the relevant information (e.g., desired category, minimum rating, etc.). Next, in step 104 the mobile device 22 determines its geographic location based on an internal GPS receiver or the like as explained above.

The mobile device 22 then proceeds to step 106 in which the mobile device 22 generates and transmits a request to the attractions server 28 including the request criteria input by the user and the location information. In following step 108, the mobile device 22 receives the attraction information meeting the request criteria and displays the information on the display 34 such as exemplified in FIGS. 4-7. In step 110, the mobile device 22 determines if the user requests further detail regarding the attractions (e.g., wishes to “drill down”). If yes, the mobile device 22 proceeds to step 112 where the user sends a request for additional detail (e.g., particular A/V files) to the attractions server 28. In step 114, the mobile device 22 receives the additional detail meeting the user's criteria, and displays the additional detail on the display 34.

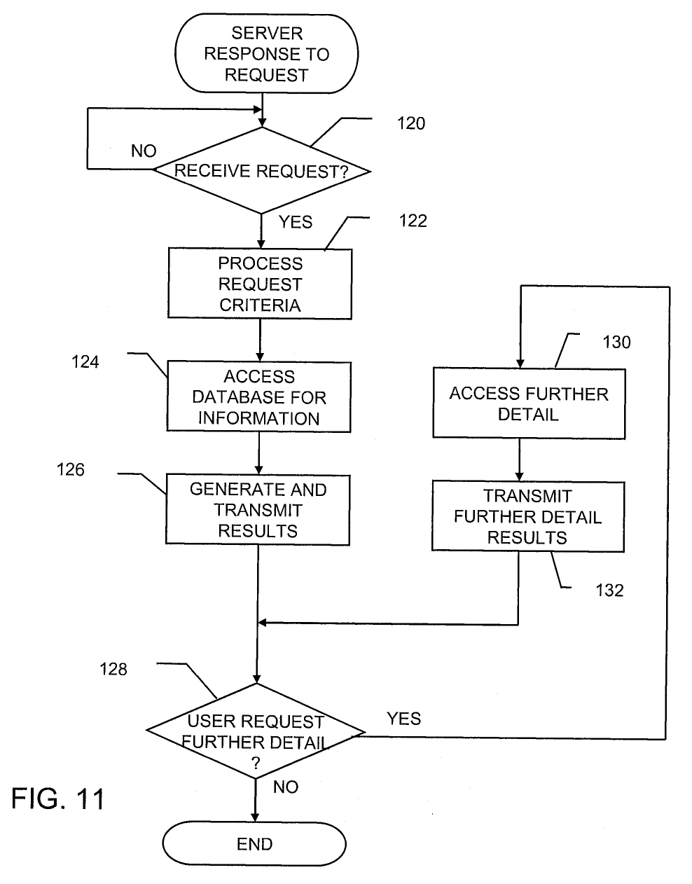

FIG. 11 illustrates a flowchart suitable for programming the attractions server 28 to respond to requests for information received from the mobile devices 22. For example, in step 120 the attractions server 28 determines if a request for information has been received (e.g., as a result of step 106 in FIG. 10). If yes, the attractions server 28 in step 122 processes the criteria provided by the user in the request. For example, the attractions server 28 determines the range of locations included within a predefined radius of the geographic location provided with the request, determines whether the user has identified particular categories, minimum ratings, group interests, etc. Based on such criteria, the attractions server 28 in step 124 accesses its database and retrieves information relating to attractions meeting such criteria.

Next, in step 126 the attractions server 28 generates and transmits a response including the retrieved information to the requesting mobile device 22 where it is then displayed (e.g., step 108 in FIG. 10). In step 128 the attractions server 28 determines if a request for additional detail, such as a request for a particular A/V file, has been received from the mobile device 22 (step 112 in FIG. 10). If yes, the attractions server 28 accesses the additional detail from its database and transmits the additional detail to the mobile device 22 as represented in steps 130 and 132, respectively.

FIG. 12 is a flowchart suitable for programming a mobile device 22 to upload attraction information, including A/V files, to the attractions server 28 as exemplified in FIGS. 8A-8F. In step 140 the mobile device 22 determines if the user has taken a picture using the camera, for example, or otherwise has obtained an A/V file representative of an attraction. If yes, the mobile device 22 proceeds to step 142 in which it determines whether the user has selected to share the attraction (e.g., as represented in FIG. 8A). If no, the mobile device 22 treats the A/V file as it would a conventional photograph, etc. If yes in step 142, the mobile device 22 prompts the user in step 144 to input corresponding information (e.g., brief description, comments, category, group affiliation, rating, etc., as exemplified in FIGS. 8B-8F). In addition, the mobile device 22 determines its location based on its internal GPS receiver. Thereafter, the mobile device 22 generates a tag including the information input by the user together with the location information as represented in step 146. Next, in step 148 the mobile device 22 transmits the A/V file together with the corresponding information included in the tag to the attractions server 28.

It will be appreciated that some or all of the steps shown in FIG. 12 may be carried out at the time of acquiring the A/V file (e.g., taking a picture), or at a subsequent time without departing from the scope of the invention. For example, the mobile device 22 may be configured to record the location information and associate such information with the A/V file at the time the A/V files is acquired. Subsequently, while at home, on an airplane, etc., the user may input the information regarding brief description, comments, ratings, etc. The user can then use the mobile device 22 to upload the A/V file and corresponding information at a subsequent time. In the case of a mobile phone, the user may upload A/V files via its radio transmitter and the mobile phone network. Alternatively, the user may prefer to upload such A/V files and their corresponding information at a later time via a direct internet connection so as to avoid calling charges associated with mobile phone communications.

As a further alternative, the mobile device 22 may be configured such that the user may acquire one or more A/V files, and upload the A/V files to the attractions server 28 with a brief description. The user may then subsequently log on to the attractions server 28 via the mobile device 22, a personal computer via the Internet, or the like, and then add additional details, edit the previously provided description, add additional pictures/video, etc.

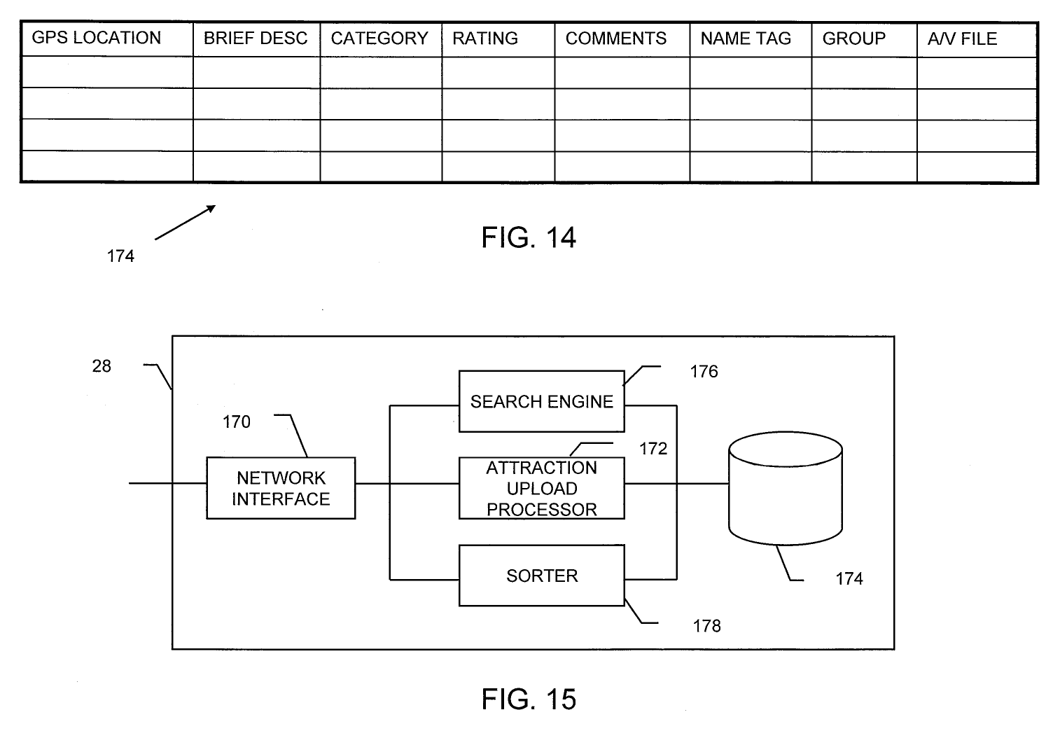

FIG. 13 is a flowchart suitable for programming the attractions server 28 to carry out processing of the A/V files and corresponding information received from the mobile devices 22 (e.g., via step 148 in FIG. 12). For example, in step 150 the applications server 28 determines if it has received an A/V file (e.g., picture) and corresponding tag information. If yes, the applications server 28 uses such A/V file and tag information to populate its database as represented in step 152. FIG. 14 illustrates an exemplary database included in the applications server 28. The database includes fields corresponding to the geographic location of the attraction (GPS Location) as provided by the mobile device uploading the A/V file. In addition, the database includes fields representing any brief description, category information, ratings, comments, group share information, and corresponding A/V file name. Additionally, the database may include name tag information identifying the user of the particular mobile device 22 which uploaded the information in the event another user wishes to request attractions based on the particular user who recommended the attraction.

FIG. 15 is a simplified block diagram representing the functions of the attractions server 28. As will be appreciated, the attractions server 28 may be made up of one or more computerized devices programmed to operate in accordance with the description herein. The attractions server 28 includes a network interface 170 that serves to connect the attractions server 28 to the network 24 (FIG. 1). The attractions server 28 further includes an attraction upload processor 172 responsible for receiving the uploading of attraction A/V files and corresponding information from the various mobile devices 22 (e.g., as a result of step 148) and populating the attractions server 28 database 174 (e.g., step 152) as exemplified in FIG. 14. The attractions server 28 also includes a search engine 176 which serves to access information from the database 174 based on requests provided by mobile devices 22 and the corresponding criteria included in the requests (e.g., steps 122, 124). In addition, the search engine 176 responds to the request by providing the corresponding information obtained from the database 174 to the requesting mobile device 22 via the network 24 (e.g., step 126).

In the exemplary embodiment of FIG. 15, the attractions server 28 also includes an optional sorter function 178 for managing the database 174. For example, different users of the mobile devices 22 will likely use slightly varying descriptions for the same attractions. For example, a first user taking a picture of the Old North Church in Boston may describe the picture specifically as “Old North Church”. A second user, on the other hand, may describe the attraction simply as “Church” or “Church on Freedom Trail”. The sorter 178 may function to analyze the description and/or other fields of various submissions from different users in order to provide a more standardized entry in the database 174. Thus, the sorter 178 may function to determine the most common description for the majority of submissions associated with a given attraction at a particular geographic location. Thus, when the search engine 176 provides information relating to surrounding attractions in response to a request by a user, the search engine 176 may refer to the attraction be the name most commonly associated with the attraction by other users.

Although not shown, the attractions server 28 may be further configured to allow users or members, other than the user who submitted a particular attraction, to review and/or comment on the particular entries. For example, a user submitting an attraction as described herein may bill the attraction as “fun for all ages”. Unbeknownst to the user submitting the attraction, however, the particular attraction may not be suitable for children on Friday night due to an after work crowd, etc. The present invention allows another user to log onto the attractions server 28 (via a mobile device 22 or otherwise) and review the particular entries posted by other users. Thus, in the present example another user knowing that the location may be unsuitable for children on Friday night can add a comment in the database indicating such. Accordingly, when still another user downloads the attractions information from the attractions server 28 based on the location of the mobile device 22 as previously described, that user will be able to receive all the comments, including both “fun for all ages” and “may not be suitable for children on Friday nights”.

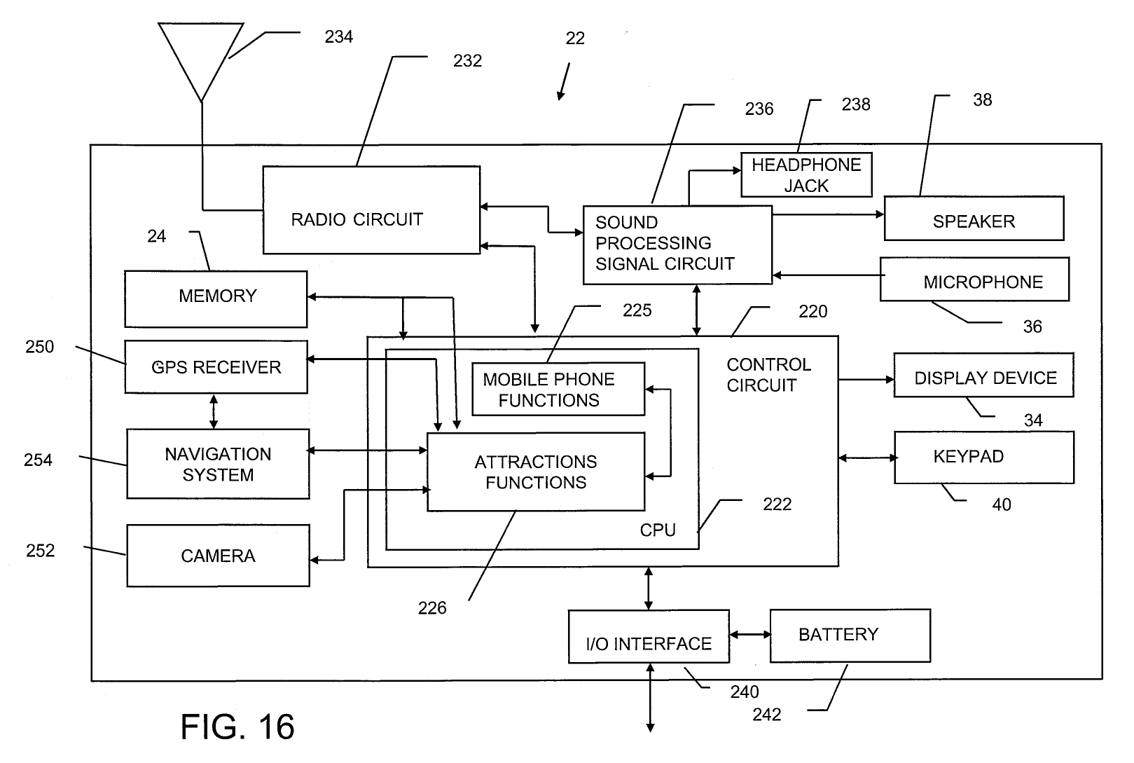

FIG. 16 is a functional block diagram of an exemplary mobile device 22, particularly in the case where the mobile device 22 is a mobile phone 22. The construction of the mobile phone 22 is generally conventional with the exception of the attractions capabilities described herein. Preferably, such capabilities are implemented primarily via software within the mobile phone 22. However, it will be apparent to those having ordinary skill in the art that such operation can be carried out via primarily software, hardware, firmware, or combinations thereof, without departing from the scope of the invention.

The mobile phone 22 includes a primary control circuit 220 that is configured to carry out overall control of the functions and operations of the mobile phone 22. The control circuit 220 may include a CPU, microcontroller, or microprocessor, etc., collectively referred to herein simply as a CPU 222. The CPU 222 executes code stored in memory (not shown) within the control circuit 220, and/or in a separate memory 224 in order to carry out conventional operation of the mobile phone functions 225 within the mobile phone 22. In addition, the CPU 222 executes code similarly stored in memory to carry out the attractions functions 226 described herein.

Continuing to refer to FIG. 16, the mobile phone 22 includes an antenna 70 coupled to a radio circuit 232. The radio circuit 232 includes a radio frequency transmitter and receiver for transmitting and receiving signals via the antenna 234 as is conventional. Such signals may be for the purpose of conventional mobile phone calls, as well as to link the mobile phone 22 to the WAN network 24 and attractions server 28 as previously described. The mobile phone 22 further includes a sound processing circuit 236 that processes the audio signal transmitted by/received from the radio circuit 232. In addition, the sound processing circuit 236 serves to process an audio signal provided by the control circuit 220 during playback of media files, recording of an audio clip, etc. Also coupled to the sound processing circuit 236 are the aforementioned microphone 36 and speaker 28, and a headset jack 238, for example. The radio circuit 232 and sound processing circuit 236 are each coupled to the control circuit 220 that carries out overall operational control.

The mobile phone 22 also includes the aforementioned display 34, keypad 40, and buttons 42a and 42b (not shown). The mobile phone 22 further includes an I/O interface 240. The I/O interface 240 may be in the form of any one of many typical mobile phone I/O interfaces, such as a multi-element connector at the base of the mobile phone 22. As is typical, the I/O interface 240 may be used to couple the mobile phone 22 to a battery charger to charge a power supply unit (e.g., battery) 242 within the mobile phone 22. Further, the I/O interface 240 may serve to connect the mobile phone 22 to a personal computer or other device via a data cable, etc., in order to download photographs or perform various other operations. For example, the mobile phone 22 may be connected directly to the Internet and network 24 via the I/O interface 76 so as not to require use of the radio circuit 232 to upload A/V files and information to the attractions server 28.

The mobile phone 22 further includes the aforementioned GPS receiver 250 for providing location information as to the particular location of the mobile phone 22 when requesting information regarding nearby attractions and/or when uploading information relating to a particular attraction. In addition, the mobile phone 22 includes the aforementioned camera 252 for capturing images and/or videos that may be converted into digital A/V files and stored in the mobile phone 22 as is conventional. These same A/V files can then be uploaded to the attractions server 28 as described herein.

FIG. 16 also shows how the mobile phone 22 or other type mobile device may also include a navigation system 254 for providing mapping and directional information between the current location of the mobile device 22 and the particular attraction(s) of interest selected by the user. In a mobile device 22 that does not include an internal navigation system 254, the attractions server 28 can provide regional mapping information and/or directions in combination with the other attractions information described herein. In a mobile device 22 that does include its own navigation system 254, however, the navigation system 254 may generate internally mapping information and/or directions between the current location of the user and one or more attractions selected by the user based on the locations of the attractions as provided by the attractions server 28. In either case, the mobile device 22 may be programmed to providing mapping and/or directions to the user upon request (e.g., by pressing a predefined button, or the like).

In view of the above detailed description, those having ordinary skill in the art will appreciate that the present invention provides a means by which people may promptly obtain detailed information relating to various attractions. Moreover, people may provide quickly and conveniently their own information, comments, suggestions with regard to various attractions.

The term “mobile device” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A mobile device network, comprising:
a network server;
a plurality of mobile devices, each of the mobile devices comprising:
an audio and/or video (A/V) capture section for obtaining an A/V file;
a positioning section for ascertaining a geographic location of the mobile device; and
a network transmitter for transmitting the A/V file and location information provided by the positioning section in association with the A/V file to the network server.

2. The network of claim 1, wherein each mobile device further includes a user interface that enables a user to input information relating to the A/V file.

3. The network of claim 1, wherein the network server comprises a database for storing A/V files provided by the plurality of mobile devices along with the location information associated with the A/V files.

4. The network of claim 3, wherein the network server further comprises a search engine for accessing the A/V files in the database as a function of the location information associated with the A/V files.

5. The network of claim 4, wherein each mobile device comprises a request engine that enables a user to generate an information request that includes location information provided by the positioning section, and the network transmitter transmits the information request to the network server.

6. The network of claim 5, wherein in response to receiving the information request from the mobile device, the network server search engine identifies particular ones of the A/V files and/or information associated with the A/V files from the database based on the location information included in the information request.

7. The network of claim 6, wherein the information request further includes particular search criteria provided by the user via the mobile device, and the search engine identifies the particular ones of the A/V files and/or information associated therewith based on the particular search criteria.

8. The network of claim 7, wherein the network server transmits all or part of the identified A/V files and/or information associated therewith to the mobile device that had provided the information request.

9. The network of claim 8, wherein the request engine in the mobile is enabled to allow a user to generate a request for more detailed information regarding the all or part of the identified A/V files and/or information associated therewith in response to receiving the all or part of the identified A/V files and/or information associated therewith.

10. The network of claim 1, wherein the A/V capture section comprises a camera for capturing a scene representative of a current geographic location of the mobile device to produce an image-based file, and the positioning section ascertains the current geographic location of the mobile device.

11. The network of claim 10, wherein the network transmitter automatically attaches the current geographic location of the mobile device to the image-based file prior to being uploaded to the network server.

12. The network of claim 11, wherein the mobile device enables a user to attach additional information to the image-based file prior to being uploaded to the network server.

13. The network of claim 12, wherein the additional information includes at least one of user description, comments, ratings or user group affiliation.

14. A mobile device, comprising:
an audio and/or video (A/V) capture section for obtaining an A/V file;
a positioning section for ascertaining a geographic location of the mobile device; and
a network transmitter for transmitting the A/V file and location information provided by the positioning section in association with the A/V file to a network server.

15. The mobile device of claim 14, wherein the mobile device further includes a user interface that enables a user to input information relating to the A/V file.

16. The mobile device of claim 14, wherein the mobile device comprises a request engine that enables a user to generate an information request that includes location information provided by the positioning section, and the network transmitter transmits the information request to the network server.

17. The mobile device of claim 16, wherein the information request further includes particular search criteria provided by the user via the mobile device, and the search engine identifies the particular ones of the A/V files and/or information associated therewith based on the particular search criteria.

18. The mobile device of claim 14, wherein the A/V capture section comprises a camera for capturing a scene representative of a current geographic location of the mobile device to produce an image-based file, and the positioning section ascertains the current geographic location of the mobile device.

19. The mobile device of claim 18, wherein the network transmitter automatically attaches the current geographic location of the mobile device to the image-based file prior to being uploaded to the network server.

20. The mobile device of claim 19, wherein the mobile device enables a user to attach additional information to the image-based file prior to being uploaded to the network server.

21. The mobile device of claim 20, wherein the additional information includes at least one of user description, comments, ratings or user group affiliation.

22. A mobile device, comprising:
a positioning section for ascertaining a geographic location of the mobile device;
a network transmitter which transmits a request for information onto a network, the request including location information provided by the positioning section; and
a network receiver for receiving one or more A/V files relating to the location information in response to the request.

23. The mobile device of claim 22, wherein the mobile device further includes a user interface that enables a user to input search criteria that is included in the request.
